(19) United States
(12) Patent Application Publication
(10) Pub. No.: US 2012/0099572 A1
(43) Pub. Date: Apr. 26, 2012

(54) COMMUNICATION DEVICE, COMPUTER PROGRAM PRODUCT, AND METHOD OF CONTROLLING OPERATION OF COMMUNICATION DEVICE

(75) Inventors: Masato Kato, Nagoya-shi (JP); Daisuke Yamada, Nagoya-shi (JP)

(73) Assignee: Buffalo Inc., Nagoya-shi (JP)

(21) Appl. No.: 13/275,591

(22) Filed: Oct. 18, 2011

(30) Foreign Application Priority Data
Oct. 22, 2010 (JP) 2010-237164

(51) Int. Cl. H04W 84/12

(52) U.S. Cl. 370/338

(57) ABSTRACT

A mobile communication device includes a mobile communication interface that can perform data communication through a mobile communication network and a wireless LAN interface that can selectably operates as a station or an access point to perform wireless communication. A mobile communication device can perform control in a station mode of causing the wireless LAN interface to operate as a station and control in an access-point mode of relaying communication packets through the mobile communication interface and the wireless LAN interface so the wireless LAN interface operates as an access point. The mobile communication device autonomously switches an operation mode between the station mode and the access-point mode in accordance with a communication environment.

### CROSS-REFERENCE TO RELATED APPLICATION

This application claims the benefit of Japanese Patent Application No. 2010-237164 filed on Oct. 22, 2010, the entire disclosure of which is herein incorporated by reference.

### BACKGROUND OF THE DISCLOSURE

1. Technical Field

The present disclosure relates to a communication device capable of wireless LAN communication, and a computer program product and method of controlling an operation of the communication device.

2. Description of the Related Art

Recently, mobile communication terminals become multifunctional. For example, a mobile phone terminal is known which has a mobile data communication interface and a wireless LAN (Local Area Network) communication interface (see, for example, http://www.n-keitai.com/n-06a/wf.html). This mobile phone terminal allows the wireless LAN communication interface to exclusively operate as a station that is a non-access-point client (hereinafter, referred to as a “station”) or a station which functions as an access-point (hereinafter, referred to as an “access point”). More specifically, the mobile phone terminal causes the wireless LAN communication interface to function as the station in order to establish a wireless communication with another access point. Moreover, this mobile phone terminal allows the wireless LAN communication interface to function as the access point in order to allow other stations, e.g., a game device with a station interface to be connected to the Internet through the mobile cellular phone terminal.

Such a mobile phone terminal needs, however, user's input operation that causes the wireless LAN communication interface to function as either one of the station or the access point using a GUI (Graphical User Interface) displayed on a display of the mobile phone terminal. Such an operation is troublesome for the user. As recognized by the present inventor, the same can be said not only for the mobile phone terminal but also for a communication terminal that is capable of causing a wireless LAN communication interface to function as both access point and station (see, for example, http://buffalo.jp/product/wireless-lan/ap/mobile/dwr-pg).

In turn, the present inventor recognized the possibilities of improving the user-friendliness of a communication device that is capable of causing a wireless LAN communication interface to exclusively function as both access point and station.

### SUMMARY

A first aspect of one embodiment is a communication device that includes: a wireless LAN interface; a wireless communication control unit that causes the wireless LAN interface to selectably operate as one of a station and an access point to control wireless communication; a mobile communication control unit that controls data exchange through a mobile communication network; and an operation control unit that autonomously switches, in accordance with a communication environment, an operation mode between a station mode in which the wireless LAN Interface operates as the station, and an access-point mode in which the wireless LAN interface operates as the access point, and relays wireless communications controlled by the wireless communication unit through the mobile communication network controlled by the mobile communication control unit.

The communication device employing the above-explained configuration includes the wireless LAN interface, the wireless communication control unit that causes the wireless LAN interface to selectably operate as a station or an access point in order to control a wireless communication, and the mobile communication control unit that controls data exchange through a mobile communication network, and switches the operation mode between the station mode and the access-point mode in order to control a wireless communication. Hence, when operating in the station mode, the communication device can communicate with an access point, and can communicate with an external network by a communication through the mobile communication network. Moreover, when operating in the access-point mode, the communication device relays a communication through the mobile communication network and a wireless communication controlled by the wireless communication control unit. Accordingly, the communication device can communicate with the external network by a communication through the mobile communication network, and provides a function as an access point to any other stations in order to allow any other stations to communicate with the external network by a communication through the mobile communication network. In addition, since the communication device autonomously switches the operation mode between the station mode and the access-point mode in accordance with a communication environment, a user does not need to manually operate the communication device in order to switch the operation mode between the station mode and the access-point mode, thereby dispensing with manual operation switching between the station mode and the access-point mode and improving the user-friendliness.

When the communication device receives a predetermined probe request through the wireless LAN interface when the communication device operates in the station mode, the operation control unit may switch an operation mode of the communication device from the station mode to the access-point mode.

In this case, the predetermined probe request may include identification information that is stored at the communication device.

Further, when a presence of an access point other than the communication device is detected when the communication device operates in the station mode, the operation control unit may prohibit switching from the station mode to the access-point mode.

In this case, even when a presence of an access point other than the communication device is detected, the operation control unit may determine a communication status of the access point, and may permit a mode switching from the station mode to the access-point mode when the communication status does not satisfy a predetermined condition.

Moreover, the communication device may further include a determining unit that determines through a predetermined determining process a presence/absence of a station other than the communication device, the any station having established a communication connection with the communication device through the wireless LAN interface when the communication device operates in the access-point mode, in which if the determining unit determines that there is no station other than the communication device that has established a connection when the communication device operates in the access-point mode, the operation control unit may switch an operation mode of the communication device from the access-point mode to the station mode.

In this case, the determining process executed by the determining unit may include a process of managing a status of establishing/releasing of a connection between the communication device and any station other than the communication device, and when a managed status of establishing/releasing of a connection corresponds to a status in which there is no station other than the communication device, the station attempting to establish a connection, the determining unit may determine that there is no station present other than the communication device.

Further in this case, the determining process executed by the determining unit may include a process of monitoring reception of any communication packets from any stations other than the communication device, and if no communication packet is received from a station other than the communication device for a predetermined time period, the determining unit may determine that there is no station present other than the communication device.

Or, the determining process executed by the determining unit may include a process of transmitting data frames to any station other than the communication device through the wireless LAN interface and of checking a response to the transmitted data frames, and if no response is received, the determining unit may determine that there is no station present other than the communication device.

The communication device may further include a power receiving unit configured to be connectable with a secondary battery that supplies power to the communication device and which receives the power from the secondary battery, in which when a remaining battery level of the secondary battery becomes equal to or lower than a predetermined value when the communication device operates in the station mode, the operation control unit may prohibit a mode switching from the station mode to the access-point mode.

The communication device may further include temperature detector that detects a temperature inside a casing of the communication device or a surface thereof, in which when a detected temperature becomes equal to or higher than a predetermined value when the communication device operates in the station mode, the operation control unit may prohibit a mode switching from the station mode to the access-point mode.

The communication device may further include: a receiver that receives a predetermined instruction; and a setting information providing unit that provides, based on the predetermined instruction, setting information including information on a setting of a wireless communication through the wireless LAN interface to a station other than the communication device through a communication via the wireless LAN interface using a protocol executed between an access point and a station, in which when the receiver unit receives the predetermined instruction when the communication device operates in the station mode, the operation control unit may switch an operation mode of the communication device from the station mode to the access-point mode.

An operation of the communication device may include a server operation as a DHCP server, and the communication device may be controlled with enabling the server operation in the access-point mode.

An operation of the communication device may include a client operation as a DHCP client, and the communication device may be controlled with enabling the client operation in the station mode.

The communication device may include a transmitter that transmits a beacon in the station mode, in which when a predetermined frame for establishing a connection for the wireless communication is received through the wireless LAN interface when the communication device operates in the station mode, the operation control unit may switch an operation mode of the communication device from the station mode to the access-point mode.

The communication device may further include a mobile communication interface that performs communication through the mobile communication network.

Alternatively, the communication device may further include a connection interface that is connectable with the mobile communication interface that performs communication through the mobile communication network.

The present invention can be realized as, in addition to the above-explained communication device, a communication control program applied to the communication device, a non-transitory computer readable medium that has the program instructions stored therein, an operation control method of a communication device described below, and an operation control method of a wireless LAN interface, etc.

That is, a second aspect of the one embodiment provides a method of controlling an operation of a communication device. The method includes: autonomously switching an operation mode between a station mode and an access point mode, the station mode causing a wireless LAN interface to operate as a station, and the access-point mode causing the wireless LAN interface to operate as an access point in accordance with a communication environment; and relaying via the wireless LAN interface mobile data communications and wireless LAN communications when the communication device operates in the access-point mode.

One aspect of the method includes receiving a predetermined probe request through the wireless LAN interface when the communication device operates in the station mode, and

performing the autonomously switching from the station mode to the access point mode in response to receiving the predetermined probe request.

In a non-transitory computer readable storage device embodiment, the storage device has instructions stored therein that when executed by a processing circuit performs a method, features of the method include

autonomously switching an operation mode between a station mode and an access point mode, the station mode causing a wireless LAN interface to operate as a station, and the access-point mode causing the wireless LAN interface to operate as an access point in accordance with a communication environment; and

relaying via the wireless LAN interface mobile data communications and wireless LAN communications when the communication device operates in the access-point mode.

### BRIEF DESCRIPTION OF THE DRAWINGS

FIG. 1A is an explanatory diagram illustratively showing a use situation of a mobile communication device 20 according to a first embodiment;

FIG. 1B is an explanatory diagram illustratively showing another use situation of the mobile communication device 20 according to the first embodiment;

FIG. 2 is an explanatory diagram showing a general configuration of the mobile communication device 20 according to the first embodiment;

FIG. 3 is a flowchart showing a flow of an operation mode switching process (when in a station mode operation) by the mobile communication device 20 according to the first embodiment;

FIG. 4 is a flowchart showing a flow of an operation mode switching process (when in an access-point mode operation) by the mobile communication device 20 according to the first embodiment;

FIG. 5 is a flowchart showing another flow of an operation mode switching process (when in an access-point mode operation) by the mobile communication device 20 according to the first embodiment;

FIG. 6 is an explanatory diagram showing a general configuration of a mobile communication device 420 according to a second embodiment; and

FIG. 7 is a flowchart showing a flow of an operation mode switching process (when in a station mode operation) by the mobile communication device 420 according to the second embodiment.

### DETAILED DESCRIPTION

Embodiments will be explained with reference to the accompanying drawings.

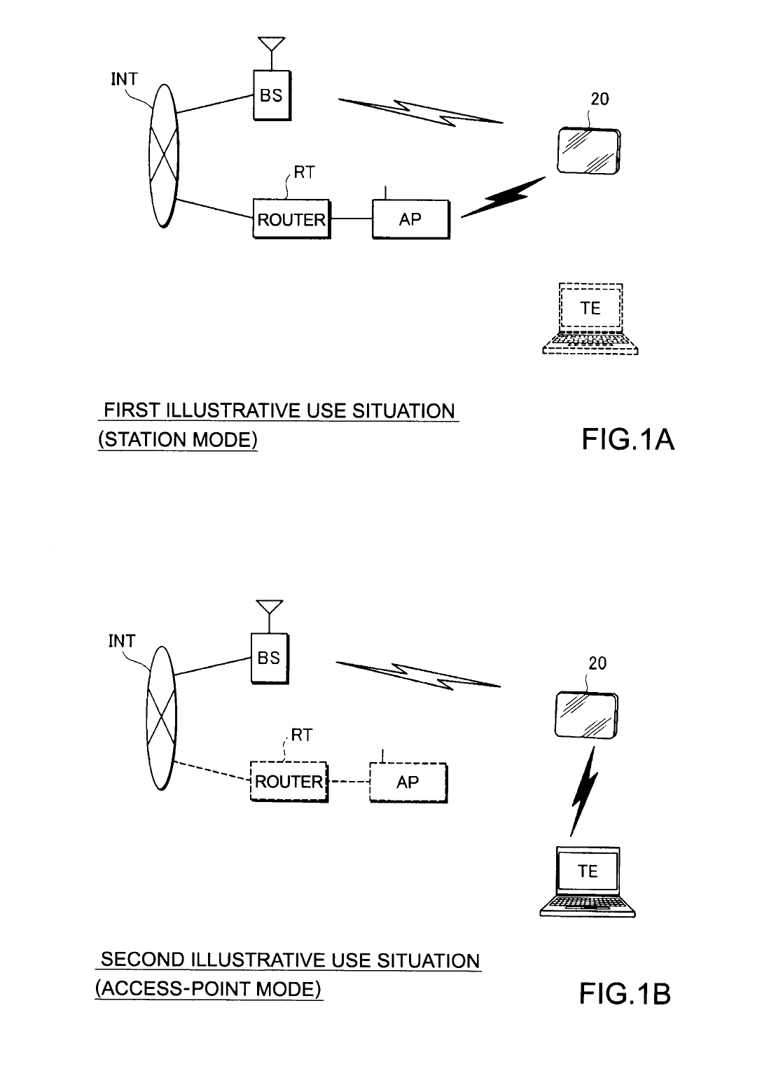

FIGS. 1A and 1B illustratively show a use situation of a mobile communication device 20 according to a first embodiment. The mobile communication device 20 is a PDA (Personal Digital Assistant) as a data terminal. The mobile communication device 20 is configured to be capable of a wireless communication through a mobile communication network and a wireless communication based on a wireless LAN. In the case of a wireless communication based on the wireless LAN, the mobile communication device 20 can operate in two operation modes: a station mode; and an access-point mode. The mobile communication device 20 can be used in two kinds of configurations depending on the difference between such operation modes.

FIG. 1A illustratively shows a first use situation of the mobile communication device 20. The first use situation relates to a method of using the mobile communication device 20 when the mobile communication device 20 operates in the station mode. As shown in the figure, the mobile communication device 20 that operates in the station mode performs, as a station, wireless communication with an access point AP based on a wireless LAN. The access point AP is connected to a router RT, and is further connected to the Internet INT that is an external network through an ISP (Internet Service Provider, not shown). Moreover, the mobile communication device 20 can be accessed to the Internet INT by a wireless communication utilizing a mobile communication network through a base station BS. In the first use situation, a terminal TE illustrated as a station is indicated by a dashed line assuming that it is not used, but the terminal TE may communicate with the access point AP. In this case, the mobile communication device 20 and the terminal TE can communicate wirelessly with each other through the access point AP.

FIG. 1B illustratively shows a second use situation of the mobile communication device 20. The second use situation relates to a method of using the mobile communication device 20 when the mobile communication device 20 operates in the access-point mode. As shown in the figure, the mobile communication device 20 that operates in the access-point mode performs, as an access point, wireless communication with the terminal TE as a station based on the wireless LAN. Moreover, the mobile communication device 20 can be accessed to the Internet INT by a wireless communication utilizing the mobile communication network through the base station BS. The mobile communication device 20 has a bridge function, and is capable of relaying a communication through the wireless LAN and the mobile data communication network. Hence, the terminal TE becomes able to be accessed to the Internet INT through the mobile communication device 20 and the base station BS. The second use situation is under a circumstance where no access point AP and router RT illustrated in the figure are present, so that those devices are indicated by dashed lines. Moreover, there may be a plurality of terminal devices TE accessed to the mobile communication device 20 that operates in the access-point mode with being capable of communicating.

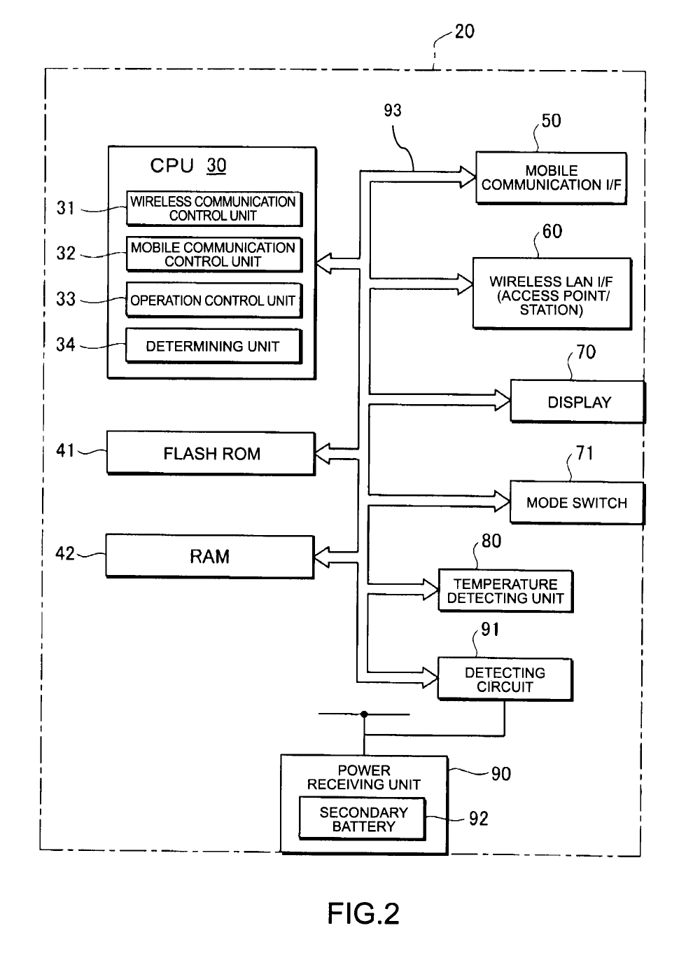

FIG. 2 shows a general configuration of the mobile communication device 20 of the present embodiment. As shown in the figure, the mobile communication device 20 includes a CPU (Central Processing Unit) 30, a flash ROM (Read Only Memory) 41, a RAM (Random Access Memory) 42, a mobile communication interface 50, a wireless LAN interface 60, a display 70, a mode switch 71, a temperature detecting unit 80, and a detecting circuit 91, each connected to one another through a bus 93. The mobile communication device 20 also includes a power receiving unit 90.

The mobile communication interface 50 is a control circuit for performing wireless data communication as a terminal with the base station BS over the mobile communication network, and includes hardware resources, such as a modulator, an amplifier, and an antenna. The mobile communication interface 50 is built in the mobile communication device 20 in a manner capable of transmitting a radio wave to the exterior and of receiving a radio wave therefrom. In the present embodiment, the mobile communication interface 50 is configured to be capable of a data communication only, but may be configured further to be capable of a voice communication. In the present embodiment, the mobile communication interface 50 is based on 3G/HSPA (Third Generation/High Speed Packet Access). The standard for a mobile data communication of the present embodiment is not limited to 3G/HSPA, and may be, for example, IEEE (the Institute of Electrical and Electronics Engineers) 802.16a, IEEE 802.16m, LTE (Long Term Evolution), or LTE-Advanced instead of 3G/HSPA.

The wireless LAN interface 60 is a control circuit for performing wireless communication based on a wireless LAN, and includes hardware resources, such as a modulator, an amplifier, and an antenna. The wireless LAN interface 60 is built in the mobile communication device 20 in a manner capable of transmitting a radio wave to the exterior and of receiving a radio wave therefrom. In the present embodiment, the wireless LAN interface 60 is configured based on IEEE 802.11. The wireless LAN interface 60 exclusively operates as a station or an access point under a control of the software program running in the CPU 30.

The display 70 is a liquid crystal display device in the present embodiment. The display 70 of the present embodiment is a touch-panel type display device, and also works as an input means.

The CPU 30 sets a program such as a firmware stored in the flash ROM 41 in the RAM 42 and extracts the program, and thus the program is run in the CPU 30 in order to control the whole operation of the mobile communication device 20. Moreover, by running predetermined programs including the firmware etc., the CPU 30 functions as a wireless communication control unit 31, a mobile communication control unit 32, an operation control unit 33, and a determining unit 34. The wireless communication control unit 31 controls a wireless communication through the wireless LAN interface 60. The mobile communication control unit 32 controls a wireless communication through the mobile communication interface 50. In other words, the mobile communication control unit 32 controls a data exchange through the mobile communication network. The operation control unit 33 performs control of autonomously and alternatively switching the operation mode (called also an operation mode switching process) between the station mode that causes the wireless LAN interface 60 to function as a station and the access-point mode that causes the wireless LAN interface 60 to function as an access point in accordance with a communication environment around the mobile communication device 20. The operation mode switching process will be explained in more detail later. The determining unit 34 determines, through a predetermined process (hereinafter, referred to as a determination process), whether or not there is a station other than the mobile communication device 20 that has established a communication connection through the wireless LAN interface 60 when the mobile communication device 20 is operated in the access-point mode.

The station mode is a mode for causing the wireless LAN interface 60 to operate as a station. When performing control in the station mode, the CPU 30 realizes a wireless communication with the access point AP. Further, at this time, the CPU 30 is also capable of communicating with the base station BS through the mobile communication interface 50. That is, through operating a GUI (Graphical User Interface) displayed on the display 70 by the user of the mobile communication device 20, an access to the Internet INT through the mobile communication network or an access to the Internet INT through the access point AP and the router RT can be selectively realized. Needless to say, simultaneous access to the Internet INT through both routes is also possible.

Further, in the station mode, the CPU 30 is configured to operate also as a DHCP (Dynamic Host Configuration Protocol) client. Hence, when the mobile communication device 20 is in a communication environment in which if there is a communicable wireless device functioning as an DHCP server, for example, the access point AP has a DHCP function, when the mobile communication device 20 operates in the station mode, the mobile communication device 20 can be allocated an IP address allocated by the wireless device. Accordingly, it becomes unnecessary for the user to manually set the IP address of the mobile communication device 20 that function as a station, and thus the user-friendliness improves.

The access-point mode is a mode for causing the wireless LAN interface 60 to function as an access point. When performing control in the access-point mode, the CPU 30 relays, as an access point, communication packets transmitted from a station. Further, at this time, the CPU 30 is also capable of communicating with the base station BS through the mobile communication interface 50. Moreover, at this time, by running a predetermined program, the CPU 30 realizes a bridge function, and relays communication packets through the mobile communication interface 50 and the wireless LAN interface 60. That is, the CPU 30 performs predetermined format conversion on communication packets received through the wireless LAN interface 60, transfers the converted packets to the mobile-communication-interface-50 side, and performs predetermined format conversion on communication packets received through the mobile communication interface 50, and transfers the converted packets to the wireless-LAN-interface-60 side. Hence, the user of the mobile communication device 20 can access the Internet INT through the mobile communication network by giving an operation to the display 70, while at the same time, the user of the terminal TE can access the Internet INT through the mobile communication device 20 and the base station BS.

Moreover, according to the present embodiment, in the access-point mode, the CPU 30 is capable of realizing a router function. The router function includes a DHCP server function. That is, the CPU 30 is configured to function as a DHCP server in the access-point mode, and to allocate an IP address to any station(s) other than the mobile communication device 20, e.g., the terminal TE. Hence, the user of the terminal TE does not need to manually set the IP address of the station, and thus the user-friendliness improves.

The mode switch 71 is a manual switch for the user of the mobile communication device 20 in order to alternatively instruct which in the station mode or in the access-point mode the mobile communication device 20 operates. In the present embodiment, the mode switch 71 is a slide switch that can selectively input any one of the operation modes of the mobile communication device 20: “auto switching”; “station mode”; and “access-point mode”. When “auto switching” is selected by the mode switch 71, the CPU 30 autonomously switches the operation mode thereof through an operation mode switching process to be discussed later. Conversely, when “station mode” or “access-point mode” is selected, the CPU 30 does not execute the operation mode switching process, but fixedly executes an operation in the selected operation mode.

The temperature detecting unit 80 includes a temperature sensor (e.g., a thermistor) that detects an interior temperature of the casing of the mobile communication device 20 or the surface thereof. The temperature detecting unit 80 converts an analog output voltage from the thermistor into a digital value, and outputs the digital value to the CPU 30. It is not necessary for the temperature detecting unit 80 to always output the voltage from the thermistor to the CPU 30, and the temperature detecting unit 80 may output a predetermined signal to the CPU 30 only when the detected temperature from the thermistor becomes equal to or higher than a predetermined value. That is, it is fine that the temperature detecting unit 80 can detect if the detected temperature becomes equal to or higher than the predetermined value. In the present embodiment, the temperature detecting unit 80 is installed near the power receiving unit 90 in the interior of the casing of the mobile communication device 20.

The power receiving unit 90 is a battery box configured to be electrically connected to a secondary battery 92 that supplies power to the mobile communication device 20. When the secondary battery 92 is retained in the power receiving unit 90, the power receiving unit 90 receives power for the mobile communication device 20 from the secondary battery 92, and supplies the power to individual units of the mobile communication device 20. FIG. 2 shows a condition in which the secondary battery 92 is retained in the power receiving unit 90. Alternatively, the power for the mobile communication device 20 may be a commercially available power supply etc. The detecting circuit 91 is electrically connected to the power receiving unit 90. The detecting circuit 91 performs analog-digital conversion of the analog output voltage from the secondary battery 92 retained in the power receiving unit 90, and outputs a digital signal to the CPU 30. It is not necessary for the power receiving unit 90 to always output the output voltage from the secondary battery 92 to the CPU 30, and may output a predetermined signal to the CPU 30 only when the output voltage from the secondary battery 92 becomes equal to or smaller than a predetermined value. That is, it is fine that the detecting circuit 91 can detect if the remaining battery level of the secondary battery 92 becomes equal to or smaller than the predetermined value.

Next, an explanation will be given of the operation mode switching process executed by the mobile communication device 20. In the present embodiment, the CPU 30 is set to operate in the station mode as a default setting. That is, when the mode switch 71 is set to be “auto switching”, if the user of the mobile communication device 20 operates a GUI displayed on the display 70 in order to activate the wireless LAN interface 60, the CPU 30 activates the wireless LAN interface 60 in the station mode. Thereafter, the CPU 30 performs a control of autonomously switching the mode between the station mode and the access-point mode depending on a communication environment of the mobile communication device 20 through the operation mode switching process. This operation mode switching process is executed by the operation control unit 33 unless otherwise mentioned specifically. An explanation will be given of the flow of the operation mode switching process separately for a case in which the wireless LAN interface 60 operates in the station mode and a case in which the wireless LAN interface 60 operates in the access-point mode.

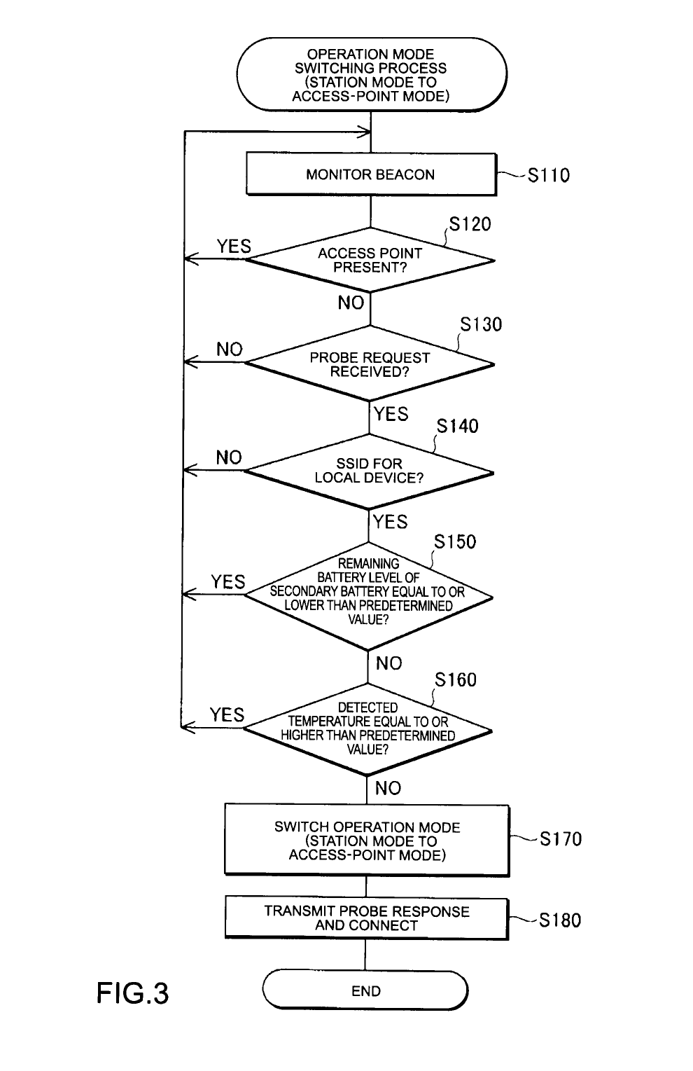

FIG. 3 shows a flow of the operation mode switching process when the wireless LAN interface 60 operates in the station mode. This process is started simultaneously with the start of the control by the CPU 30 of the mobile communication device 20 operated in the station mode. As shown in the figure, upon the start of the control in the station mode, the CPU 30 monitors a beacon transmitted by an access point other than the mobile communication device 20 (step S110).

As a result of monitoring the beacon, when receiving the beacon from at least one access point, i.e., when it is confirmed that an access point is present around the mobile communication device 20 (step S120: YES), the CPU 30 keeps monitoring the beacon until it becomes unable to receive the beacon. This process means that a mode switching from the station mode to the access-point mode is prohibited when there is an access point other than the mobile communication device 20 under the communication environment where the mobile communication device 20 is present. The reason why such a configuration is employed is to cause the access point to preferentially relay the wireless LAN communication of the terminal TE rather than that of the mobile communication device 20 when there is the access point other than the mobile communication device 20.

Conversely, when no beacon is received, i.e., when it is unable to confirm that there is an access point around the mobile communication device 20 (step S120: NO), the CPU 30 stands by for receiving a probe request transmitted from a station other than the mobile communication device 20, i.e., the terminal TE for a predetermined time period (step S130). As a result, when no probe request is received (step S130: NO), the process is returned to the step S110. Conversely, when a probe request is received within the predetermined time period (step S130: YES), it means that there is the terminal TE which requests to establish a connection with the access point under the communication environment where the mobile communication device 20 is present. Hence, the CPU 30 determines whether or not an SSID (Service Set Identifier) included in the received probe request coincides with an SSID of the local device (step S140). In the present embodiment, it is presumed that the user of the terminal TE registers the SSID of the mobile communication device 20 as an access point in advance in the terminal TE.

Upon determination, when the SSID does not coincide with the SSID of the local device (step S140: NO), e.g., when the SSID is an SSID different from the SSID of the local device or is ANY, it is presumed that the station that has transmitted the probe request is not the terminal TE that the user of the terminal TE attempts to establish a connection with the mobile communication device 20 as the access point. Hence, the CPU 30 ignores or abandons this probe request, and returns the process to the step S130. In this fashion, by limiting the probe request that triggers the switching of the operation mode in step S170 to be discussed later to a predetermined request, when a probe request is transmitted from a station not intended by the user of the mobile communication device 20, it is possible to suppress a mode switching from the station mode to the access-point mode against intension of the user of the mobile communication device 20.

Conversely, when the SSID coincides with the SSID of the local device (step S140: YES), the station that has transmitted the probe request is the terminal TE that the user of the terminal TE plans to establish a connection with the mobile communication device 20, and the user of the terminal TE wants to establish a connection between the terminal TE and the mobile communication device 20. Hence, the CPU 30 further determines whether or not the output voltage from the secondary battery 92 detected by the detecting circuit 91 is equal to or smaller than the predetermined value (step S150). This determination is for checking whether or not the remaining battery level of the secondary battery 92, i.e., the available charge is equal to or smaller than a predetermined value. The output voltage from the secondary battery 92 decreases together with the decrease of the remaining battery level of the secondary battery 92, so that when the output voltage becomes equal to or smaller than the predetermined value, it is possible to determine that the remaining battery level is equal to or smaller than the predetermined value.

Upon determination, when the remaining battery level of the secondary battery 92 is equal to or less than the predetermined value (step S150: YES), the CPU 30 returns the process to the step S130. This process means that a mode switching from the station mode to the access-point mode in the step S170 to be discussed later is prohibited when the remaining battery level of the secondary battery 92 is equal to or smaller than the predetermined value. In the access-point mode, when the terminal TE accesses the Internet INT, the mobile communication interface 50 and the wireless LAN interface 60 are simultaneously operated in the mobile communication device 20, so that power consumption is likely to become large in comparison with that in the station mode. Moreover, when the mobile communication device 20 transmits a beacon in the access-point mode, the power consumption becomes further larger. Accordingly, if a configuration is employed which prohibits a mode switching from the station mode to the access-point mode when the remaining battery level of the secondary battery 92 is low, the use of the secondary battery 92 to the full extent can be suppressed, and thus the mobile communication device 20 can operate for a long time.

Conversely, when the remaining battery level of the secondary battery 92 is larger than the predetermined value (step S150: NO), the CPU 30 determines whether or not the temperature detected by the temperature detecting unit 80 is equal to or higher than the predetermined value (step S160). As a result, when the detected temperature is equal to or higher than the predetermined value (step S160: YES), the CPU 30 returns the process to the step S130. This process means that a mode switching from the station mode to the access-point mode in the step S170 to be discussed later is prohibited when the temperature of the interior of the casing of the mobile communication device 20 is equal to or higher than the predetermined value. In the access-point mode, when the terminal TE accesses the Internet INT, the mobile communication interface 50 and the wireless LAN interface 60 are simultaneously operated in the mobile communication device 20, so that the amount of heat generation becomes large, and the temperature inside the casing of the mobile communication device 20 is likely to be higher than that in the station mode. Accordingly, if a configuration is employed which prohibits a mode switching from the station mode to the access-point mode when the temperature inside the casing of the mobile communication device 20 is equal to or higher than the predetermined value, it is possible to prevent the mobile communication device 20 from being excessively heated. As a result, a failure inherent to a temperature rise due to the heating can be prevented.

Such a configuration has a main purpose in the present embodiment to suppress a performance deterioration of the secondary battery 92 due to heating by installing the temperature detecting unit 80 in the vicinity of the power receiving unit 90. However, the failure to be prevented is not limited to the performance deterioration of the secondary battery 92, and may be a thermal runaway of the CPU 30, etc. The location where the temperature detecting unit 80 is installed can be designed in accordance with its purpose. Needless to say, a plurality of temperature detecting units 80 may be provided.

Conversely, when the detected temperature is lower than the predetermined value (step S160: NO), the CPU 30 switches the operation mode from the station mode to the access-point mode (step S170). Next, as a response to the received probe request, the CPU 30 transmits a probe response to the terminal TE, and establishes a connection with the terminal TE (step S180). Thereafter, the CPU 30 causes the wireless LAN interface 60 to operate as the access point which relays the communication packets transmitted from the terminal TE. The operation mode switching process completes this way when the mobile communication device 20 operates in the station mode.

In the above-explained operation mode switching process, the processes other than the steps S130, S170, and S180 can be skipped as needed. Moreover, a configuration may be added which periodically transmits a beacon when the CPU 30 operates in the station mode. In this case, when a predetermined frame for establishing a connection for a wireless communication is received, the CPU 30 may switch the operation mode from the station mode to the access-point mode. Examples of such predetermined frames are “Association Request” and “Authentication”. Accordingly, when the terminal TE searches an access point through a passive scan and attempts to establish a connection with the mobile communication device 20 that operates as the access point, the mode switching can be performed appropriately. When “authentication” is received and the mode switching from the station mode to the access-point mode is performed, such authentication may be limited to authentication of a shared key scheme. This prevents the mobile communication device 20 from being connected to the terminal TE not intended by the user of the mobile communication device 20. However, such authentication may include authentication of an open system scheme.

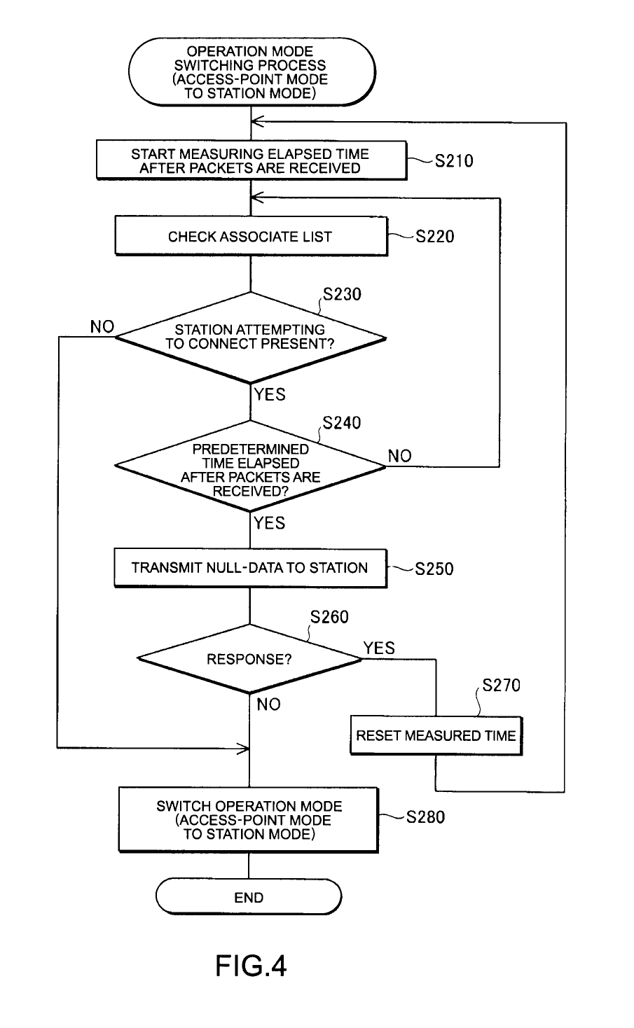

FIG. 4 shows a flow of the operation mode switching process when the wireless LAN interface 60 operates in the access-point mode. This process is started simultaneously with the start of a control by the CPU 30 of the mobile communication device 20 operated in the access-point mode. As shown in the figure, upon the start of the control in the access-point mode, the CPU 30 starts measuring an elapsed time after communication packets are received through the wireless LAN interface 60 (step S210). The elapsed time measured is reset every time the mobile communication device 20 receives communication packets through the wireless LAN interface 60.

Upon the start of measuring of the elapsed time, as the process by the determining unit 34, the CPU 30 checks an association list (step S220). The association list is prepared for managing an establishment of a connection between the mobile communication device 20 and the station other than the mobile communication device 20 (in the present embodiment, the terminal TE), and a releasing of such a connection therebetween. In the present embodiment, using the association list, the CPU 30 manages an establishment of a connection with the terminal TE and a releasing of such a connection therewith as a part of the determining process. More specifically, when the mobile communication device 20 receives the association request from the terminal TE and establishes a connection therewith, the CPU 30 registers the MAC address of the terminal TE in the association list. Moreover, when the mobile communication device 20 receives a disassociation request from the terminal TE that has already established a connection and cancels the connection therewith, the CPU 30 erases the MAC address of the terminal TE from the association list.

Upon checking of the association list, the CPU 30 determines whether or not there is the terminal TE that is the station currently attempting to establish a connection based on the check result (step S230). As a result, when there is no terminal TE currently attempting to establish a connection (step S230: NO), it is not necessary for the mobile communication device 20 to operate as the access point, so that the CPU 30 switches the operation mode from the access point mode to the station mode (step S280). Thereafter, the CPU 30 causes the wireless LAN interface 60 to operate as the station.

Conversely, when there is the terminal TE currently attempting to establish a connection (step S230: YES), there is a possibility that the terminal TE performs wireless communication with the mobile communication device 20 operating as the access point. However, it is not always true that the terminal TE transmits a disassociation request to the mobile communication device 20 when terminating the wireless communication therewith. Accordingly, as will be explained in detail later, the CPU 30 further determines whether or not there is the active terminal TE, i.e., whether or not the terminal TE actually has terminated the wireless communication with the mobile communication device 20 through an active detection that is a part of the determining process.

More specifically, the CPU 30 determines whether or not a predetermined time has elapsed after receiving a communication packet received at last (step S240). The communication packet received at last is the communication packet received at last among all communication packets received from respective terminals TE when a plurality of terminals TE are accessed to the CPU 30 by wireless LAN. As a result, when the predetermined time has not elapsed (step S220: NO), the CPU 30 returns the process to the step S220. This process is to suppress an increase of the traffic of the communication through the process in step S250 to be discussed later, and can be omitted.

Conversely, when the predetermined time has elapsed (step S240: YES), the CPU 30 transmits null data to the terminal TE as the process by the determining unit 34 (step S250). When there is the communicable terminal TE, such a terminal TE receives the null data, and transmits an ACK (ACKnowledgement) frame to the mobile communication device 20 as a response. When the null data is transmitted, the CPU 30 determines as the process by the determining unit 34 whether or not the ACK frame transmitted by the terminal TE is received (step S260). The processes in the steps S250 and S260 are executed as a part of the determining process. When the CPU 30 receives the ACK frame, it means that there is the communicable terminal TE around the mobile communication device 20, and when no ACK frame is received, it means that no communicable terminal TE is present around the mobile communication device 20.

Upon the determination, when the ACK frame is received (step S260: YES), the communicable terminal TE is present around the mobile communication device 20, so that there is a highly possibility that the terminal TE continuously transmits communication packets to the mobile communication device 20. Accordingly, the CPU 30 resets the measured time that the CPU 30 starts measuring in the step S210 (step S270), and returns the process to the step S210. This means that the CPU 30 maintains the control in the access-point mode. This prevents the CPU 30 from switching the operation mode when the transmission interval becomes long incidentally even though the user of the mobile communication device 20 desires the mobile communication device 20 to operate in the access-point mode.

Conversely, when no ACK frame is received (step S260: NO), the communicable terminal TE becomes absent around the mobile communication device 20, so that the terminal TE will not transmit communication packets to the mobile communication device 20. Accordingly, the CPU 30 switches the operation mode from the access-point mode to the station mode (step S280). Thus way, the operation mode switching process when the mobile communication device 20 operates in the access-point mode completes.

According to the above-explained operation mode switching process, the mobile communication device 20 transmits null data, and checks a response thereof, thereby checking the presence/absence of the terminal TE through an active detection. However, it is fine if the active detection is to transmit a data frame to the terminal TE and to check a response thereof. For example, instead of the null data, or in addition thereto, an echo request using a ping may be transmitted. Since the terminal TE transmits an echo reply as a response when receiving the echo request, when the CPU 30 receives the echo reply, there is the communicable terminal TE around the mobile communication device 20, and when no echo reply is received, it is possible to determine that there is no communicable terminal TE around the mobile communication device 20. The presence/absence of the terminal TE can be precisely checked through the active detection.

In such an active detection, the CPU 30 may transmit null data and an echo request multiple times, and may determine that there is the communicable terminal TE when receiving a response at least once. Alternatively, null data and an echo request may be both transmitted and the CPU 30 may determine that the communicable terminal TE is present when a response of at least either one of the null data and the echo request is received. According to such a configuration, the determination precision of the presence/absence of the terminal TE can be improved.

The mobile communication device 20 employing the above-explained configuration according to the present embodiment includes the mobile communication interface 50 and the wireless LAN interface 60 that can exclusively and alternatively function as the station or the access point, and the operation mode is controlled so as to be switched between the station mode and the access-point mode. Hence, when a control in the station mode is performed, the mobile communication device 20 can communicate with the terminal TE through the access point AP. If the access point AP is connected to the Internet INT, the mobile communication device 20 can also access the Internet INT through the access point AP. Furthermore, the mobile communication device 20 can access the Internet INT by a communication through the mobile communication interface 50. Moreover, when a control in the access-point mode is performed, the mobile communication device 20 can access the Internet INT by a communication through the mobile communication interface 50 and provides the function as an access point to the terminal TE, which allows the terminal TE to access the Internet INT by a communication through the mobile communication interface 50.

Hence, when the user of the mobile communication device 20 and the user of the terminal TE are the same and such a user requests to access the Internet INT through the terminal TE, the user can access the Internet INT from the terminal TE through the mobile communication device 20. Moreover, when the user of the mobile communication device 20 and the user of the terminal TE are not same and the user of the mobile communication device 20 does not use the wireless LAN function of the mobile communication device 20, the user of the terminal TE can effectively use the unused wireless LAN function of the mobile communication device 20, and can access the Internet INT from the terminal TE. In addition, the mobile communication device 20 autonomously switches the operation mode between the station mode and the access-point mode depending on the communication environment, so that the user of the mobile communication device 20 does not need a work of switching the operation mode between the station mode and the access-point mode, thereby improving the user-friendliness.

Moreover, when receiving the predetermined probe request in an operation in the station mode, the mobile communication device 20 switches the operation mode from the station mode to the access-point mode. Reception of the predetermined probe request means that there is the terminal TE that requests to connect with the mobile communication device 20 as the access point under a communication environment where the mobile communication device 20 is present, so that the mode switching can be appropriately realized depending on the communication environment.

Furthermore, under a communication environment where the access point AP that is an access point other than the mobile communication device 20 is present, the mobile communication device 20 prohibits the mode switching from the station mode to the access-point mode. It is not necessary in the station mode to transmit a beacon, and the power consumption of the communication device becomes little in comparison with the access-point mode, so that the power consumption of the mobile communication device 20 can be reduced according to such a configuration. As a result, the limited battery level of the secondary battery as the power supply of the mobile communication device 20 can be effectively used. Even though such a configuration is employed, the terminal TE can perform wireless communication with the access point AP based on wireless LAN, so that there is no problem for the user of the terminal TE. Moreover, when performing the operation mode switching process, the default operation mode is set to be the station mode, so that the power consumption of the mobile communication device 20 can be reduced.

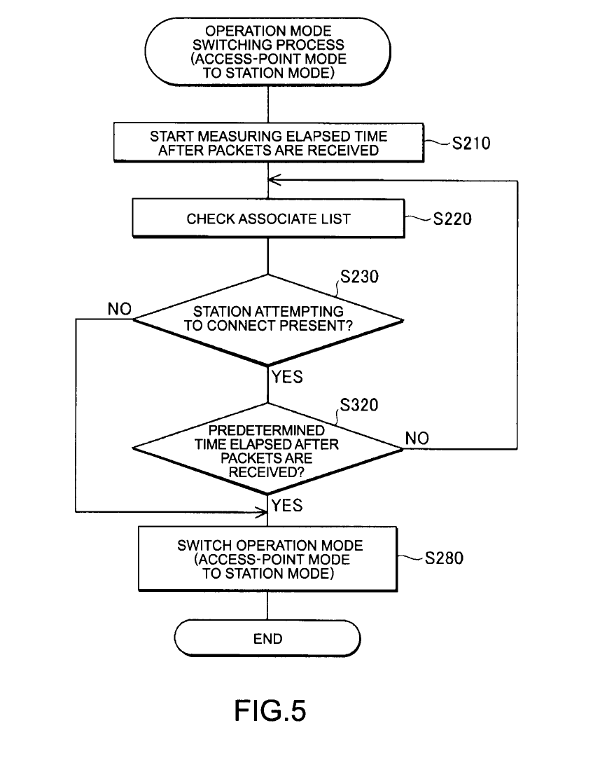

Next, an explanation will be given of a mobile communication device according to a second embodiment of the present invention with reference to FIG. 5. The hardware configuration of the mobile communication device 20 according to the second embodiment is same as that of the first embodiment. The difference of the mobile communication device 20 of the second embodiment from the first embodiment is only the flow of the operation mode switching process when the mobile communication device 20 operates in the access-point mode. Such a difference will be explained with reference to FIG. 5. In FIG. 5, the same process as that of the first embodiment will be denoted by the same reference numeral as that of FIG. 4 and the duplicated explanation will be omitted.

As shown in the figure, upon the start of a control in the access-point mode, the CPU 30 starts measuring an elapsed time after receiving communication packets through the wireless LAN interface 60, and monitors reception of the communication packets as a part of the determining process (step S210). Next, the CPU 30 checks, as the process by the determining unit 34, an association list (step S220). Upon the checking of the association list, the CPU 30 determines whether or not there is the terminal TE currently attempting to establish a connection (step S230). As a result, when there is no terminal TE attempting to establish a connection (step S230: NO), the CPU 30 switches the operation mode from the access-point mode to the station mode (step S280).

Conversely, when there is the terminal TE attempting to establish a connection (step S230: YES), the CPU 30 checks the active/non-active status of the terminal TE through a passive detection. More specifically, the CPU 30 determines, as the process by the determining unit 34, whether or not a predetermined time has elapsed after receiving a communication packet received at last (step S320). The communication packet received at last is a communication packet received at last among all communication packets received from respective terminals TE when a plurality of terminals TE are connected to the CPU 30 by wireless LAN. As a result, when the predetermined time has not elapsed (step S320: NO), the CPU 30 returns the process to the step S220. Conversely, when the predetermined time has elapsed (step S320: YES), there is a highly possibility that the communicable terminal TE does not exist anymore under the communication environment around the mobile communication device 20. Hence, the CPU 30 switches the operation mode from the access-point mode to the station mode (step S280). Accordingly, the operation mode switching process when the mobile communication device 20 operates in the access-point mode completes.

As is clear from the above explanation, according to the second embodiment, the reception status of communication packets is monitored and the active/non-active status of the terminal TE is checked through a passive detection based on the reception time interval of the received communication packets. According to such a configuration, in comparison with a case in which an active detection is performed, the process can be simplified and thus it is efficient. In addition, the traffic of the communication using the wireless LAN interface 60 can be reduced, so that the communication load can be reduced.

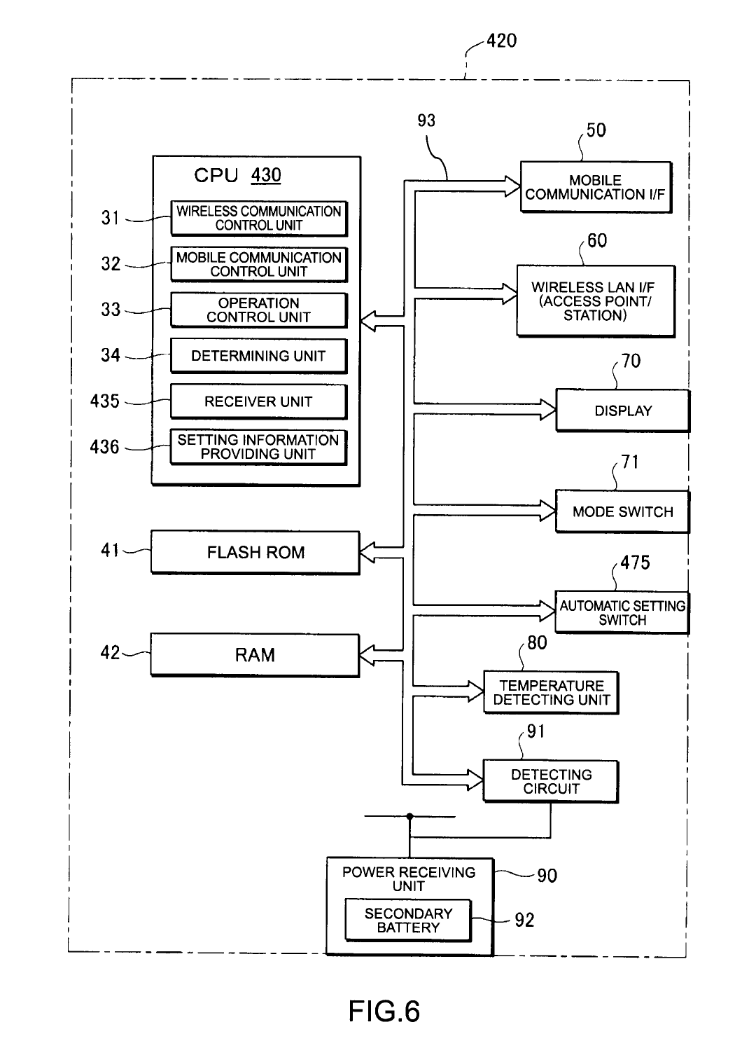

Next, an explanation will be given of a mobile communication device 420 according to a third embodiment of the present invention. The differences of the mobile communication device 420 of the present embodiment from the first embodiment are the configuration of the mobile communication device 420 and the flow of the operation mode switching process when the mobile communication device 420 operates in the station mode. The explanation below will be given of only the differences of the mobile communication device 420 from the first embodiment, and the duplicated explanation for the common point will be omitted. FIG. 6 shows a general configuration of the mobile communication device 420 according to the third embodiment. In FIG. 6, the same structural element as that of the first embodiment will be denoted by the same reference numeral as that of FIG. 2, and the duplicated explanation will be omitted. The mobile communication device 420 differs from the first embodiment in that a CPU 430 further functions as a receiver unit 435 and a setting information providing unit 436, and the mobile communication device 420 further includes an automatic setting switch 475. Respective functions of the receiver unit 435 and the setting information providing unit 436 will be discussed in detail later.

The automatic setting switch 475 is a manual switch for instructing an activation of an AOSS (AirStation One-touch Secure System, registered trademark of BUFFALO Inc.) that automatically sets setting information on the setting of a wireless communication through the wireless LAN interface 60. According to the AOSS, when the user of the mobile communication device 420 gives a predetermined activation instruction to an access point and a station, an asymmetric protocol is executed between the access point and the station, and the access point provides setting information on an encryption, an authentication, etc., of a network device to the station through a wireless LAN communication. Since the AOSS is conventionally well-known, the detailed explanation thereof will be omitted in the specification, but when receiving an AOSS activation instruction, the access point changes the state thereof to a standby state for a setting request. Conversely, when receiving the AOSS activation instruction, the station transmits a setting request to the access point. When receiving the setting request in the standby state for the setting request, the access point performs wireless LAN communication with the station, and provides setting information to the station. The station applies the provided setting information to the local device, and establishes a connection with the access point.

It is appropriate if the automatic setting switch 475 is an interface for automatically setting the setting information, and when, for example, the CPU 430 is capable of realizing a WPS (Wi-Fi Protected Setup) function, the automatic setting switch 475 may be a WPS switch. Alternatively, instead of the automatic setting switch 475, an activation instruction may be given through a GUI, etc., displayed on the display 70.

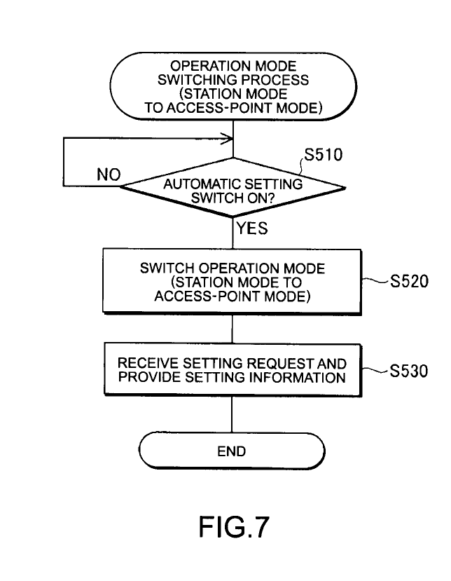

FIG. 7 shows a flow of the operation mode switching process executed by the mobile communication device 420 when operating in the station mode. As shown in the figure, upon the start of the operation mode switching process, the CPU 430 of the mobile communication device 420 first determines whether or not an AOSS activation instruction is received as the process by the receiver unit 435, i.e., whether or not the automatic setting switch 475 is depressed by the user of the mobile communication device 420 (step S510). This process is continuously executed until an AOSS activation instruction is received (step S510: NO). Next, when receiving the AOSS activation instruction (step S510: YES), the CPU 430 switches the operation mode from the station mode to the access-point mode as the process by the operation control unit 33 (step S520).

When the operation mode is switched, the CPU 430 receives the setting request transmitted by the terminal TE that has received the AOSS activation instruction, and provides the setting information to the terminal TE by a wireless communication through the wireless LAN interface 60 as the process by the setting information providing unit 436 (step S530). Thus way, the operation mode switching process when the mobile communication device 420 operates in the station mode completes. It is needless to say that such an operation mode switching process may be executed concurrently with the operation mode switching process of the first or second embodiment.

The mobile communication device 420 employing the above-explained configuration according to the present embodiment can appropriately switch the operation mode in a communication environment where the mobile communication device 420 as the access point causes the terminal TE as the station to automatically provide setting information through the AOSS, etc., in order to execute a setting for wireless communication of the terminal TE.

According to the above-explained embodiments, the explanation was given of a configuration having the mobile communication interface 50 and the wireless LAN interface 60 separately provided from the CPU 30. However, at least either one of the mobile communication device 50 and the wireless LAN interface 60 may be incorporated in the CPU 30. Such a configuration is known as WiSoC (Wireless System on a Chip). Moreover, according to the above-explained embodiments, the mobile communication device 20 includes the mobile communication interface 50 built therein. However, it is not always necessary for the mobile communication device 20 to include the mobile communication interface 50 built therein, and the mobile communication device 20 may include an interface connectable with the mobile communication interface 50. Examples of such an interface are a USB (Universal Serial Bus) and an SDIO (Secure Digital Input/Output). When a data communication card capable of a mobile data communication, e.g., a USB modem including a modem therein is connected to such an interface, the same working and effect as those of the above-explained embodiments can be obtained. In addition, if the mobile communication interface 50 is detachable, it is appropriate if a desirable mobile communication interface 50 is connected when the user of the mobile communication device 20 wants to separately use different mobile communication networks provided by a plurality of carriers or telecommunication corporations, so that the user-friendliness improves. Moreover, when the mobile communication interface 50 capable of performing fast-speed communication in comparison with existing products becomes available, and the user of the mobile communication device 20 wants to use such an interface, it is fine if merely the mobile communication interface 50 is replaced, and it is not necessary for the user of the mobile communication device 20 to renew the whole mobile communication device 20, so that the user-friendliness improves, which contributes to resource saving.

According to the above-explained embodiments, the explanation was given of a configuration that fixedly executes respective processes in the operation mode switching process, but the content of the operation mode switching process may be switched depending on a situation. When, for example, the remaining battery level of the secondary battery 92 becomes equal to or lower than a predetermined value, the process may be switched to a process in an energy-saving mode. As an example process in the energy-saving mode, for example, respective predetermined times in the step S220 and the step S320 may be switched so as to be relatively short. This makes the time at which the mobile communication device 20 operates in the access-point mode relatively short, so that a time period at which a beacon is transmitted can be shortened, and thus a time period at which the mobile communication interface 50 and the wireless LAN interface 60 are simultaneously operated can be shortened, thereby accomplishing an energy saving. Alternatively, as the process in the energy-saving mode, a configuration may be employed, which prohibits a transmission of a beacon during an operation in the access-point mode. Furthermore, when a configuration that transmits a beacon during an operation in the station mode is employed, as the process in the energy-saving mode, a configuration may be employed which prohibits a transmission of the beacon. Needless to say, the mode switching to the energy-saving mode can be manually operated through, for example, a GUI displayed on the display 70.

According to the above-explained embodiments, when the remaining battery level of the secondary battery 92 becomes equal to or lower than the predetermined value or when the detected temperature by the temperature detecting unit 80 becomes equal to or higher than the predetermined value, the mode switching from the station mode to the access-point mode is prohibited. In addition to such a configuration or instead thereof, when the remaining battery level of the secondary battery 92 becomes equal to or lower than the predetermined value or when the detected temperature by the temperature detecting unit 80 becomes equal to or higher than the predetermined value during an operation in the access-point mode, the mode switching from the access-point mode to the station mode may be forcibly performed.

In the above-explained embodiments, the explanation was given of a configuration that determines the remaining battery level of the secondary battery 92 based on the output voltage by the secondary battery 92. However, how to determine the remaining battery level is not limited to any particular scheme. For example, a sensor that physically or optically detects the retaining of the secondary battery 92 may be provided in the power receiving unit 90 that retains the secondary battery 92 therein, an operation time is measured after the secondary battery 92 is newly retained, and an available battery level of the secondary battery 92 may be estimated based on the measured operation time. When a configuration that estimates the available battery level based on the operation time is employed, the operation time in the access-point mode and the operation time in the station mode may be separately measured, and the available battery level of the secondary battery 92 may be estimated. This improves the precision of the estimation of the available battery level since the power consumption in the access-point mode largely differs from the power consumption in the station mode.

In the operation mode switching process shown in FIG. 3, the mode switching from the station mode to the access-point mode is prohibited when there is an access point other than the mobile communication device 20, but such a configuration may be modified. When, for example, an access point other than the mobile communication device 20 is detected based on a reception of a beacon, if the RSSI (Received Signal Strength Indication) of the beacon is equal to or smaller than a predetermined value, the mode switching from the station mode to the access-point mode may be allowed. Alternatively, when an access point other than the mobile communication device 20 is detected on the basis of a reception of a beacon, a connection may be established with that access point, a predetermined number of communication packets may be transmitted to the access point in order to measure a PER (Packet Error Rate), and when the PER is equal to or greater than a predetermined value, the mode switching from the station mode to the access-point mode may be allowed. In this fashion, when the mobile communication device 20 determines a communication status of the detected access point, and the mode switching from the station mode to the access-point mode is allowed if the communication status to that access point is not good, the terminal TE can perform wireless communication in a good communication status.

In the above-explained embodiments, as an illustrative communication device to which the present invention is applied, the configuration of the mobile communication device 20 was explained. However, the present invention can be realized as various communication devices, such as a laptop computer, a portable router device, and a mobile phone. In particular, when the communication device of the present invention is realized as a mobile phone, the user-friendliness improves. More specifically, most people own respective mobile phones and carry them in recent days, so that a user who uses an information processing device provided with only a station function as a communication unit can access the Internet INT from any location where a mobile communication network is available using the information processing device and the mobile phone as long as he/she carries the mobile phone without carrying any special device.

Those communication devices may include an interface other than the mobile communication interface 50 and the wireless LAN interface 60. For example, the communication device may include a wired LAN interface, and may be configured as an Ethernet (registered trademark) converter that relays communication packets through the wired LAN interface and the wireless LAN interface 60. In this case, when an input/output device of various data, such as video data, and audio data, is connected to the wired LAN interface, the terminal TE may input/output various data to/from a device connected to the wired LAN interface through the communication device. Alternatively, the communication device may include a USB interface. In this case, when a portable storage device like a hard disk is connected to the USB interface, the terminal TE may input/output data to/from the storage device.

The embodiments of the present invention were explained above, but the present invention is not limited to the above-explained embodiments, and can be switched and modified in various forms without departing from the scope and the spirit of the present invention. For example, in addition to the form of a communication device, the present invention can be realized as, for example, a communication control program applied to a communication device, a storage media storing such a program, and an operation control method of a wireless LAN interface.

What is claimed is:

1. A communication device comprising:
a wireless LAN interface;
a wireless communication control unit that causes the wireless LAN interface to selectably operate as one of a station and an access point to control wireless communication;
a mobile communication control unit that controls data exchange through a mobile communication network; and
an operation control unit that autonomously switches, in accordance with a communication environment, between
a station mode in which the wireless LAN interface operates as the station, and
an access-point mode in which the wireless LAN interface operates as the access point, and relays wireless communications controlled by the wireless communication control unit through the mobile communication network controlled by the mobile communication control unit.

2. The communication device according to claim 1, wherein
when the communication device receives a predetermined probe request through the wireless LAN interface when the communication device operates in the station mode, the operation control unit switches an operation mode of the communication device from the station mode to the access-point mode.

3. The communication device according to claim 2, wherein the predetermined probe request includes identification information that is stored at the communication device.

4. The communication device according to claim 1, wherein
when a presence of an access point other than the communication device is detected when the communication device operates in the station mode, the operation control unit prohibits switching from the station mode to the access-point mode.

5. The communication device according to claim 4, wherein
even when a presence of an access point other than the communication device is detected, the operation control unit determines a communication status of the access point, and permits a mode switching from the station mode to the access-point mode when the communication status does not satisfy a predetermined condition.

6. The communication device according to claim 1, further comprising:
a determining unit that determines through a predetermined determining process a presence/absence of any station other than the communication device, the any station having established a communication connection with the communication device through the wireless LAN interface when the communication device operates in the access-point mode,
wherein if the determining unit determines that there is no station other than the communication device that has established a connection when the communication device operates in the access-point mode, the operation control unit switches an operation mode of the communication device from the access-point mode to the station mode.

7. The communication device according to claim 6, wherein
the determining process executed by the determining unit includes a process for managing a status of establishing/releasing of any connection between the communication device and any station other than the communication device, and
when a managed status of establishing/releasing of any connections corresponds to a status in which there is no station other than the communication device attempting to establish a connection, the determining unit determines that there is no station present other than the communication device.

8. The communication device according to claim 6, wherein
the determining process executed by the determining unit includes a process for monitoring reception of any communication packets from any station other than the communication device, and
when no communication packet is received from any station other than the communication device for a predetermined time period, the determining unit determines that there is no station present other than the communication device.

9. The communication device according to claim 6, wherein
the determining process executed by the determining unit includes a process for transmitting data frames to any station other than the communication device through the wireless LAN interface and for checking a response to the transmitted data frames, and
when no response is received, the determining unit determines that there is no station present other than the communication device.

10. The communication device according to claim 1, further comprising:
a power receiving unit configured to be connectable with a secondary battery that supplies power to the communication device and which receives the power from the secondary battery,
wherein when a remaining battery level of the secondary battery becomes equal to or lower than a predetermined value when the communication device operates in the station mode, the operation control unit prohibits a mode switching from the station mode to the access-point mode.

11. The communication device according to claim 1, further comprising:
a temperature detector that detects a temperature inside a casing of the communication device or a surface thereof,
wherein when a detected temperature becomes equal to or higher than a predetermined value when the communication device operates in the station mode, the operation control unit prohibits a mode switching from the station mode to the access-point mode.

12. The communication device according to claim 1, further comprising:
a receiver that receives a predetermined instruction; and
a setting information providing unit that provides, based on the predetermined instruction, setting information including information on a setting of a wireless communication through the wireless LAN interface to a station other than the communication device by a communication through the wireless LAN interface using a protocol executed between an access point and a station,
wherein when the receiver unit receives the predetermined instruction when the communication device operates in the station mode, the operation control unit switches an operation mode of the communication device from the station mode to the access-point mode.

13. The communication device according to claim 1, wherein
an operation of the communication device includes a server operation as a DHCP server, and
the server operation is enabled in the access-point mode.

14. The communication device according to claim 1, wherein
an operation of the communication device includes a client operation as a DHCP client, and
the client operation is enabled in the station mode.

15. The communication device according to claim 1, further comprising:
a transmitter that transmits a beacon when the communication device operates in the station mode, and
when a predetermined frame for establishing a connection for the wireless communication is received through the wireless LAN interface when the communication device operates in the station mode, the operation control unit switches an operation mode of the communication device from the station mode to the access-point mode.

16. The communication device according to claim 1, further comprising:
a mobile communication interface that performs communication through the mobile communication network.

17. The communication device according to claim 1, further comprising:
a connection interface that is connectable with the mobile communication interface that performs communication through the mobile communication network.

18. A method for controlling an operation of a communication device, the method comprising:
autonomously switching an operation mode between a station mode and an access point mode, said station mode causing a wireless LAN interface to operate as a station, and the access-point mode causing the wireless LAN interface to operate as an access point in accordance with a communication environment; and
relaying via the wireless LAN interface mobile data communications and wireless LAN communications when the communication device operates in the access-point mode.

19. The method of claim 18, further comprising
receiving a predetermined probe request through the wireless LAN interface when the communication device operates in the station mode, and
performing the autonomously switching from the station mode to the access point mode in response to receiving said predetermined probe request.

20. A non-transitory computer readable storage device having instructions stored therein that when executed by a processing circuit performs a method comprising:
autonomously switching an operation mode between a station mode and an access point mode, said station mode causing a wireless LAN interface to operate as a station, and the access-point mode causing the wireless LAN interface to operate as an access point in accordance with a communication environment: and
relaying via the wireless LAN interface mobile data communications and wireless LAN communications when the communication device operates in the access-point mode.
